(19) United States
(12) Patent Application Publication
(10) Pub. No.: US 2025/0238271 A1
(43) Pub. Date: Jul. 24, 2025

(54) SYSTEM AND METHOD FOR OPTIMIZING CONFIGURATION OF RESOURCE UPGRADES

(71) Applicant: BANK OF AMERICA CORPORATION, Charlotte, NC (US)

(72) Inventors: Steven Nathan Greene, Scarsdale, NY (US); Stephen Richard Belton, Garden City, NY (US); Srinath S. Chakravarty, Plano, TX (US); Aravind Shankaragouda Singtalur, McKinney, TX (US); Petar Evan Puskarich, Murphy, TX (US); Dinesh Kumar Agrawal, Rowlett, TX (US); Manmohan V. Datla, Frisco, TX (US); Kenneth L. Boyd, Mechanicsville, VA (US); Kerry M. Vaughan, Lawrenceville, NJ (US); Elina Shkodnik, Staten Island, NY (US)

(73) Assignee: BANK OF AMERICA CORPORATION, Charlotte, NC (US)

(21) Appl. No.: 18/417,739

(22) Filed: Jan. 19, 2024

(51) Int. Cl. G06F 9/50; G06F 9/451

(52) U.S. Cl. CPC G06F 9/5033; G06F 9/451

(57) ABSTRACT

Embodiments of the present invention provide a system for optimizing configuration of resource upgrades. The system is configured for identifying entity resources that meet conditions associated with upgrading the entity resources, identifying rules associated with upgrading the entity resources, determining change windows for upgrading the entity resources based at least on the rules, generating a schedule for upgrading the entity resources based on the rules and the change windows, displaying the schedule for upgrading the entity resources to a user, via a dynamic editable user interface, prompting the user to provide an input associated with the schedule via the dynamic editable user interface, receiving the response from the user via the dynamic editable user interface, and automatically upgrading the entity resources based on the schedule and the response received from the user.

### BACKGROUND

There exists a need for a system for optimizing configuration of resource upgrades.

### BRIEF SUMMARY

Embodiments of the present invention address the above needs and/or achieve other advantages by providing apparatuses (e.g., a system, computer program product and/or other devices) and methods for optimizing configuration of resource upgrades. The system embodiments may comprise one or more memory devices having computer readable program code stored thereon, a communication device, and one or more processing devices operatively coupled to the one or more memory devices, wherein the one or more processing devices are configured to execute the computer readable program code to carry out the invention. In computer program product embodiments of the invention, the computer program product comprises at least one non-transitory computer readable medium comprising computer readable instructions for carrying out the invention. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the invention.

In some embodiments, the present invention identifies one or more entity resources that meet one or more conditions associated with upgrading the one or more entity resources, identifies one or more rules associated with upgrading the one or more entity resources, determines one or more change windows for upgrading the one or more entity resources based at least on the one or more rules, generates a schedule for upgrading the one or more entity resources based on the one or more rules and the one or more change windows, displays the schedule for upgrading the one or more entity resources to a user, via a dynamic editable user interface, prompts the user to provide an input associated with the schedule via the dynamic editable user interface, receives the response from the user via the dynamic editable user interface, and in response to receiving the response from the user, automatically upgrades the one or more entity resources based on the schedule and the response received from the user.

In some embodiments, receiving the response from the user comprises receiving at least one change to the schedule via one or more edit functionalities in the dynamic editable user interface.

In some embodiments, the present invention determines that the at least one change complies with the one or more rules and is in alignment with the one or more change windows and modifies the schedule based on the at least one change.

In some embodiments, the present invention identifies at least one entity resource of the one or more entity resources as a critical resource and displays the at least one entity resource in the schedule via one or more highlighter graphical elements.

In some embodiments, the present invention prompts the user to provide an input associated with the at least one entity resource in the schedule via the dynamic editable user interface and receives the response associated with the at least one entity resource from the user via the dynamic editable user interface.

In some embodiments, the one or more rules comprise at least one of application requirements, freeze requirements, network requirements, and resiliency requirements. In some embodiments, the one or more conditions comprise at least one of malfunctioning of at least one hardware component, expiration of warranty of one or more components of the one or more entity systems, availability of new software updates, availability of new hardware upgrades, scheduled transfer of data, and availability of new data required for performing one or more actions.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 provides a block diagram illustrating a system environment for optimizing configuration of resource upgrades, in accordance with an embodiment of the invention;

FIG. 2 provides a block diagram illustrating the entity system 200 of FIG. 1, in accordance with an embodiment of the invention;

FIG. 3 provides a block diagram illustrating a resource upgrade configuration system 300 of FIG. 1, in accordance with an embodiment of the invention;

FIG. 4 provides a block diagram illustrating the computing device system 400 of FIG. 1, in accordance with an embodiment of the invention;

FIG. 5 provides a process flow for optimizing configuration of resource upgrades, in accordance with an embodiment of the invention; and

FIG. 6 provides a block diagram illustrating the process of optimizing configuration of resource upgrades, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As described herein, the term “entity” may be any organization that utilizes one or more entity resources for performing one or more organization activities, where the entity resources may include, but are not limited to, applications, servers, databases, networks, devices, automated machines, machines, operating systems, and/or the like. In some embodiments, the entity may be a financial institution which may include herein may include any financial institutions such as commercial banks, thrifts, federal and state savings banks, savings and loan associations, credit unions, investment companies, insurance companies and the like. In some embodiments, the entity may be a non-financial institution.

Many of the example embodiments and implementations described herein contemplate interactions engaged in by a user with a computing device and/or one or more communication devices and/or secondary communication devices. A “user”, as referenced herein, may refer to an entity or individual that has the ability and/or authorization to access and use one or more applications, systems, servers, and/or devices provided by the entity and/or the system of the present invention. Furthermore, as used herein, the term “user computing device” or “mobile device” may refer to mobile phones, computing devices, tablet computers, wearable devices, smart devices and/or any portable electronic device capable of receiving and/or storing data therein.

A “user interface” is any device or software that allows a user to input information, such as commands or data, into a device, or that allows the device to output information to the user. For example, the user interface includes a graphical user interface (GUI) or an interface to input computer-executable instructions that direct a processing device to carry out specific functions. The user interface typically employs certain input and output devices to input data received from a user or to output data to a user. These input and output devices may include a display, mouse, keyboard, button, touchpad, touch screen, microphone, speaker, LED, light, joystick, switch, buzzer, bell, and/or other user input/output device for communicating with one or more users.

Typically, an entity utilizes one or more entity resources to perform one or more organizational activities, where the one or more entity resources may comprise applications, systems, servers, devices, databases, automated machines, operating systems, and/or the like. Entity resources have to upgraded regularly to meet technological advancements and security standards and also to prevent unauthorized users from gaining access to entity resources. However, the entity resources may be dependent on each other and while updating a resource, downtime of that resource may affect other resources and may also affect users of that resource. As such, there exists a need for a system to optimally configure the upgrades of the one or more entity resources so that the upgrades cause minimal disruptions to users and other entity resources. The system of the present invention solves these problems as discussed in detail below.

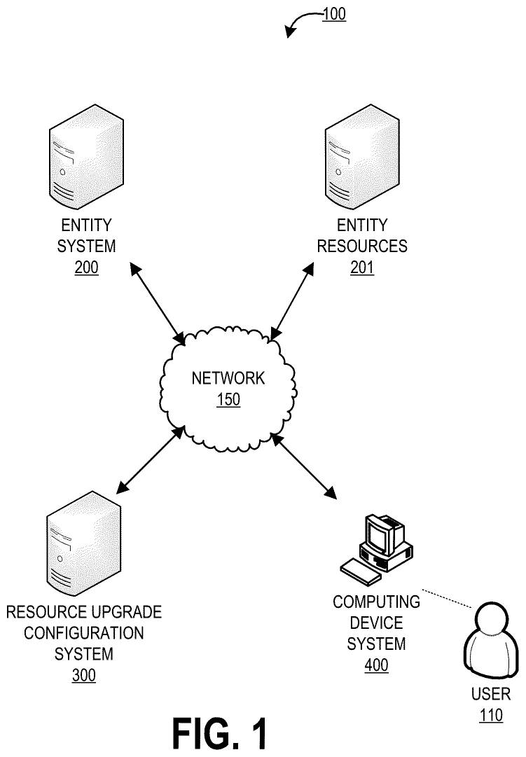

FIG. 1 provides a block diagram illustrating a system environment 100 for optimizing configuration of resource upgrades, in accordance with an embodiment of the invention. As illustrated in FIG. 1, the environment 100 includes a resource upgrade configuration system 300, entity system(s) 200, entity resources 201, and a computing device system 400. One or more users 110 may be included in the system environment 100, where the users 110 interact with the other entities of the system environment 100 via a user interface of the computing device system 400. In some embodiments, the one or more user(s) 110 of the system environment 100 may be employees of an entity associated with the entity system 200. Employees of the entity may include, but are not limited to, full-time employees, part-time employees, contractors, consultants, service providers, and/or the like. In some embodiments, the one or more user(s) 110 of the system environment 100 may be customers of the entity associated with the entity system 200. In some embodiments, the one or more user(s) 110 of the system environment 100 may be potential customers of the entity associated with the entity system 200.

The entity system(s) 200 may be any system owned or otherwise controlled by an entity to support or perform one or more process steps described herein. In some embodiments, the entity is a financial institution. In some embodiments, the entity is a non-financial institution. In some embodiments, the entity may be a service provider. The entity may be any organization that utilizes one or more entity resources 201 to perform one or more organizational activities, where the one or more entity resources 201 need to be updated on a regular basis.

The resource upgrade configuration system 300 is a system of the present invention for performing one or more process steps described herein. In some embodiments, the resource upgrade configuration system 300 may be an independent system. In some embodiments, the resource upgrade configuration system 300 may be a part of the entity system 200. In some embodiments, the functionalities described herein that are provided by the resource upgrade configuration system 300 may be provided as a service to multiple entities instead of a single entity. In some such embodiments, data associated each entity may be maintained separately by the resource upgrade configuration system 300.

The resource upgrade configuration system 300, the entity system 200, the entity resources 201, and/or the computing device system 400 may be in network communication across the system environment 100 through the network 150. The network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet. In general, the resource upgrade configuration system 300 is configured to communicate information or instructions with the entity system 200, and/or the computing device system 400 across the network 150.

The computing device system 400 may be a computing device of the user 110. In general, the computing device system 400 communicates with the user 110 via a user interface of the computing device system 400, and in turn is configured to communicate information or instructions with the resource upgrade configuration system 300 and/or entity system 200 across the network 150.

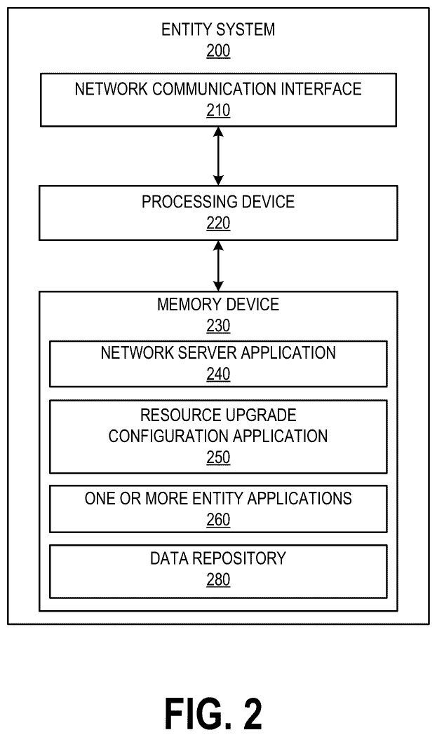

FIG. 2 provides a block diagram illustrating the entity system 200, in greater detail, in accordance with embodiments of the invention. As illustrated in FIG. 2, in one embodiment of the invention, the entity system 200 includes one or more processing devices 220 operatively coupled to a network communication interface 210 and a memory device 230. In certain embodiments, the entity system 200 is operated by an entity, such as a financial institution, while in other embodiments, the entity system 200 is operated by an entity other than a financial institution.

It should be understood that the memory device 230 may include one or more databases or other data structures/repositories. The memory device 230 also includes computer-executable program code that instructs the processing device 220 to operate the network communication interface 210 to perform certain communication functions of the entity system 200 described herein. For example, in one embodiment of the entity system 200, the memory device 230 includes, but is not limited to, a network server application 240, a resource upgrade configuration application 250, one or more entity applications 260, and a data repository 280. The computer-executable program code of the network server application 240, the resource upgrade configuration application 250, and the one or more entity applications 260 to perform certain logic, data-extraction, and data-storing functions of the entity system 200 described herein, as well as communication functions of the entity system 200.

The network server application 240, the resource upgrade configuration application 250, and the one or more entity applications 260 are configured to store data in the data repository 280 or to use the data stored in the data repository 280 when communicating through the network communication interface 210 with the resource upgrade configuration system 300, and the computing device system 400 to perform one or more process steps described herein. In some embodiments, the entity system 200 may receive instructions from the resource upgrade configuration system 300 via the resource upgrade configuration application 250 to perform certain operations. The resource upgrade configuration application 250 may be provided by the resource upgrade configuration system 300.

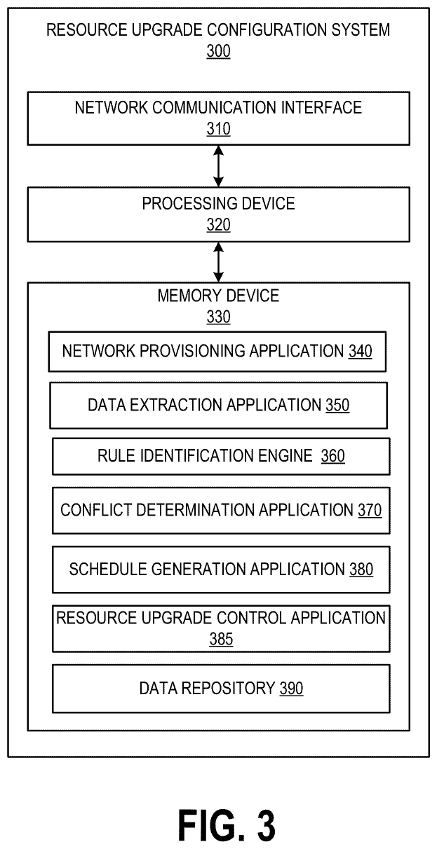

FIG. 3 provides a block diagram illustrating the resource upgrade configuration system 300 in greater detail, in accordance with embodiments of the invention. As illustrated in FIG. 3, in one embodiment of the invention, the resource upgrade configuration system 300 includes one or more processing devices 320 operatively coupled to a network communication interface 310 and a memory device 330. In certain embodiments, the resource upgrade configuration system 300 is operated by an entity, such as a financial institution, while in other embodiments, the resource upgrade configuration system 300 is operated by an entity other than a financial institution. In some embodiments, the resource upgrade configuration system 300 is owned or operated by the entity of the entity system 200. In some embodiments, the resource upgrade configuration system 300 may be an independent system. In alternate embodiments, the resource upgrade configuration system 300 may be a part of the entity system 200.

It should be understood that the memory device 330 may include one or more databases or other data structures/repositories. The memory device 330 also includes computer-executable program code that instructs the processing device 320 to operate the network communication interface 310 to perform certain communication functions of the resource upgrade configuration system 300 described herein. For example, in one embodiment of the resource upgrade configuration system 300, the memory device 330 includes, but is not limited to, a data extraction application 350, a rule identification application 360, a conflict determination application 370, a schedule generation application 380, a resource upgrade control application 385, and a data repository 390 comprising data processed or accessed by one or more applications in the memory device 330. The computer-executable program code of the network provisioning application 340, the data extraction application 350, the rule identification application 360, the conflict determination application 370, the schedule generation application 380, and the resource upgrade control application 385 may instruct the processing device 320 to perform certain logic, data-processing, and data-storing functions of the resource upgrade configuration system 300 described herein, as well as communication functions of the resource upgrade configuration system 300.

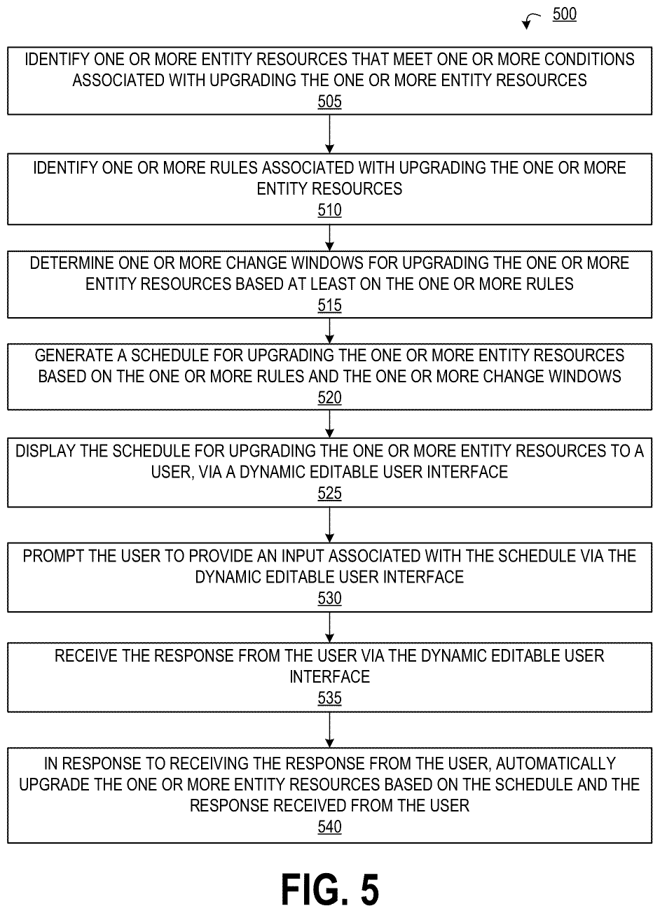

The network provisioning application 340, the data extraction application 350, the rule identification application 360, the conflict determination application 370, the schedule generation application 380, and the resource upgrade control application 385 are configured to invoke or use the data in the data repository 390 when communicating through the network communication interface 310 with the entity system 200, and the computing device system 400. In some embodiments, where the resource upgrade configuration systems 300 acts as a service and provides the functionalities associated with schedule generation and configuration to multiple entities independent of each other, data associated with each of the multiple entities may be maintained separately (e.g., partitioned or the like in the data repository 390, maintaining a separate repository similar to the data repository 390 for other entities, or the like). In some embodiments, the network provisioning application 340, the data extraction application 350, the rule identification application 360, the conflict determination application 370, the schedule generation application 380, and the resource upgrade control application 385 may store the data extracted or received from the entity system 200 and the computing device system 400 in the data repository 390. In some embodiments, the network provisioning application 340, the data extraction application 350, the rule identification application 360, the conflict determination application 370, the schedule generation application 380, and the resource upgrade control application 385 may be a part of a single application. One or more processes performed by the network provisioning application 340, the data extraction application 350, the rule identification application 360, the conflict determination application 370, the schedule generation application 380, and the resource upgrade control application 385 are described in FIGS. 5 through 7.

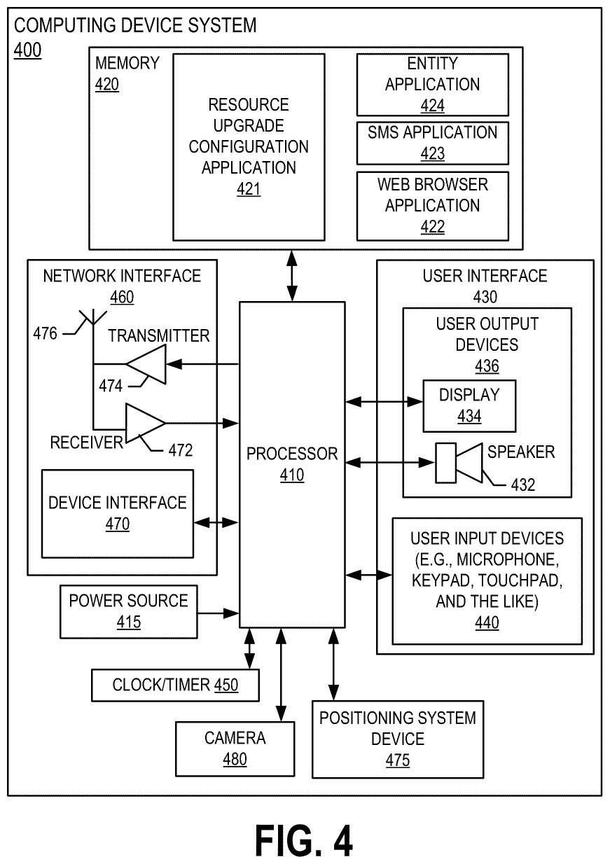

FIG. 4 provides a block diagram illustrating a computing device system 400 of FIG. 1 in more detail, in accordance with embodiments of the invention. However, it should be understood that the computing device system 400 is merely illustrative of one type of computing device system that may benefit from, employ, or otherwise be involved with embodiments of the present invention and, therefore, should not be taken to limit the scope of embodiments of the present invention. The computing devices may include any one of portable digital assistants (PDAs), pagers, mobile televisions, mobile phone, entertainment devices, desktop computers, workstations, laptop computers, cameras, video recorders, audio/video player, radio, GPS devices, wearable devices, Internet-of-things devices, augmented reality devices, virtual reality devices, automated teller machine devices, electronic kiosk devices, or any combination of the aforementioned.

Some embodiments of the computing device system 400 include a processor 410 communicably coupled to such devices as a memory 420, user output devices 436, user input devices 440, a network interface 460, a power source 415, a clock or other timer 450, a camera 480, and a positioning system device 475. The processor 410, and other processors described herein, generally include circuitry for implementing communication and/or logic functions of the computing device system 400. For example, the processor 410 may include a digital signal processor device, a microprocessor device, and various analog to digital converters, digital to analog converters, and/or other support circuits. Control and signal processing functions of the computing device system 400 are allocated between these devices according to their respective capabilities. The processor 410 thus may also include the functionality to encode and interleave messages and data prior to modulation and transmission. The processor 410 can additionally include an internal data modem. Further, the processor 410 may include functionality to operate one or more software programs, which may be stored in the memory 420. For example, the processor 410 may be capable of operating a connectivity program, such as a web browser application 422. The web browser application 422 may then allow the computing device system 400 to transmit and receive web content, such as, for example, location-based content and/or other web page content, according to a Wireless Application Protocol (WAP), Hypertext Transfer Protocol (HTTP), and/or the like.

The processor 410 is configured to use the network interface 460 to communicate with one or more other devices on the network 150. In this regard, the network interface 460 includes an antenna 476 operatively coupled to a transmitter 474 and a receiver 472 (together a “transceiver”). The processor 410 is configured to provide signals to and receive signals from the transmitter 474 and receiver 472, respectively. The signals may include signaling information in accordance with the air interface standard of the applicable cellular system of the wireless network 150. In this regard, the computing device system 400 may be configured to operate with one or more air interface standards, communication protocols, modulation types, and access types. By way of illustration, the computing device system 400 may be configured to operate in accordance with any of a number of first, second, third, and/or fourth-generation communication protocols and/or the like. For example, the computing device system 400 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, with LTE protocols, with 4GPP protocols and/or the like. The computing device system 400 may also be configured to operate in accordance with non-cellular communication mechanisms, such as via a wireless local area network (WLAN) or other communication/data networks.

As described above, the computing device system 400 has a user interface that is, like other user interfaces described herein, made up of user output devices 436 and/or user input devices 440. The user output devices 436 include a display 430 (e.g., a liquid crystal display or the like) and a speaker 432 or other audio device, which are operatively coupled to the processor 410.

The user input devices 440, which allow the computing device system 400 to receive data from a user such as the user 110 may include any of a number of devices allowing the computing device system 400 to receive data from the user 110, such as a keypad, keyboard, touch-screen, touchpad, microphone, mouse, joystick, other pointer device, button, soft key, and/or other input device(s). The user interface may also include a camera 480, such as a digital camera.

The computing device system 400 may also include a positioning system device 475 that is configured to be used by a positioning system to determine a location of the computing device system 400. For example, the positioning system device 475 may include a GPS transceiver. In some embodiments, the positioning system device 475 is at least partially made up of the antenna 476, transmitter 474, and receiver 472 described above. For example, in one embodiment, triangulation of cellular signals may be used to identify the approximate or exact geographical location of the computing device system 400. In other embodiments, the positioning system device 475 includes a proximity sensor or transmitter, such as an RFID tag, that can sense or be sensed by devices known to be located proximate a merchant or other location to determine that the computing device system 400 is located proximate these known devices.

The computing device system 400 further includes a power source 415, such as a battery, for powering various circuits and other devices that are used to operate the computing device system 400. Embodiments of the computing device system 400 may also include a clock or other timer 450 configured to determine and, in some cases, communicate actual or relative time to the processor 410 or one or more other devices.

The computing device system 400 also includes a memory 420 operatively coupled to the processor 410. As used herein, memory includes any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory can additionally or alternatively include an electrically erasable programmable read-only memory (EEPROM), flash memory or the like.

The memory 420 can store any of a number of applications which comprise computer-executable instructions/code executed by the processor 410 to implement the functions of the computing device system 400 and/or one or more of the process/method steps described herein. For example, the memory 420 may include such applications as a conventional web browser application 422, a resource upgrade configuration application 421, an entity application 424, or the like. These applications also typically instructions to a graphical user interface (GUI) on the display 430 that allows the user 110 to interact with the entity system 200, the resource upgrade configuration system 300, and/or other devices or systems. The memory 420 of the computing device system 400 may comprise a Short Message Service (SMS) application 423 configured to send, receive, and store data, information, communications, alerts, and the like via the wireless network 150.

The memory 420 can also store any of a number of pieces of information, and data, used by the computing device system 400 and the applications and devices that make up the computing device system 400 or are in communication with the computing device system 400 to implement the functions of the computing device system 400 and/or the other systems described herein.

FIG. 5 provides a process flow for optimizing configuration of resource upgrades in real-time, in accordance with an embodiment of the invention. As shown in block 505, the system identifies one or more entity resources that meet one or more conditions associated with upgrading the one or more entity resources. The one or more entity resources may be any resources utilized by an entity to perform one or more organizational activities associated with the entity, where the one or more entity resources may include, but are not limited to, applications, systems, servers, devices, databases, network systems, automated machines (e.g., Automated Teller Machines), operating systems, and/or the like. The one or more conditions may comprise malfunctioning of at least one hardware component, expiration of warranty of one or more components of the one or more entity systems, expiration of licenses of the one or more components of the one or more entity systems, availability of new software updates, availability of new hardware upgrades, scheduled transfer of data, and availability of new data required for performing one or more actions, and/or the like. In some embodiments, the system may run diagnostic checks on the one or more entity resources to determine if any entity resources meet the one or more conditions associated with upgrading the one or more entity resources. For example, the system may run diagnostic checks on the one or more entity resources to determine that a hardware component of an entity resource needs to be replaced. In another example, the system may run diagnostic checks on the one or more entity resources to determine that a software component of an entity resource needs to be upgraded. In some embodiments, the system may receive a notification associated with the one or more conditions from a third party system. For example, the system may receive a notification from a third party system regarding availability of a new software update related to an entity resource and the system may determine that one or more conditions associated with the entity resource have been met. In some embodiments, the system may receive a notification (e.g., employee of the entity) associated with the one or more conditions from the user. For example, a systems administrator may determine a need for an updated security patch to be installed on the one or more entity resources based on a security event and may notify the system. In some embodiments, the system may determine that the one or more entity resources need to be upgraded based on scheduled upgrades, scheduled transfer of data, and/or availability of new data.

As shown in block 510, the system identifies one or more rules associated with upgrading the one or more entity resources. The one or more rules associated with upgrading the one or more entity resources may comprise at least one of application requirements, freeze requirements, network requirements, resiliency requirements, and/or the like. The application requirements may comprise having ‘n’ out of ‘m’ paired devices available, predetermined limits associated with downtime, critical time slots associated with different applications, and/or the like. Freeze requirements may comprise no-change windows and/or limited controlled change windows associated with the one or more entity resources, where the no-change windows and/or the limited controlled change windows may be predefined or may be instantaneously determined based on real-time data from other entities. For example, there may be a no-change window associated with automated teller machines during a parade or any other event. Network requirements may comprise having availability of alternate network traffic routes to the routes that are provided by entity resources that are undergoing upgrades. Resiliency requirements may comprise having a set of alternate resources while upgrading the one or more entity resources to perform one or more operations associated with the one or more entity resources. In some embodiments, the system may identify the one or more rules based on data extracted from a data repository comprising information associated with the one or more entity resources (e.g., data repository 290 and data repository 390).

As shown in block 515, the system determines one or more change windows for upgrading the one or more entity resources based at least on the one or more rules. The system may determine change windows for updating the one or more resources based on at least one of the application requirements, the freeze requirements, the network requirements, the resiliency requirements, and/or the like. For example, the system may determine an optimized change window for upgrading a set of entity resources based on determining that the change window meets the resiliency requirements, where only one resource is set to be upgraded at a time from the set of entity resources, where the set of entity resources may be critical resources. In some embodiments, the system may determine the one or more change windows based on location of the one or more entity resources, groupings of the one or more entity resources, and/or the like in addition to the one or more rules. In some embodiments, the system may extract the information associated with the location and the groupings of the one or more entity resources may be stored in a data repository (e.g., data repository 290 and data repository 390).

As shown in block 520, the system generates a schedule for upgrading the one or more entity resources based on the one or more rules and the one or more change windows. The schedule generated by the system is an optimized schedule that takes into account all of the one or more rules and the one or more change windows.

As shown in block 525, the system displays the schedule for upgrading the one or more entity resources to a user, via a dynamic editable user interface. The dynamic editable user interface may comprise one or more edit functionalities which may include, but are not limited to, a drag and drop functionality, single or multiple selection, cut, and paste functionality, reordering functionality (e.g., renumbering), and/or any other functionalities that allow the users to edit the schedule generated by the system via the dynamic editable user interface. For example, the system may allow the users to edit the schedule by dragging and dropping an entity resource from a first placement in the schedule to a second placement. In some embodiments, a user may edit the schedule generated by the system based on a request from another user, where the request is associated with keeping an entity resource available to perform an operation, where the users may communicate via email.

As shown in block 530, the system prompts the user to provide an input associated with the schedule via the dynamic editable user interface. In some embodiments, the input may comprise at least one change to the generated schedule. In some other embodiments, the input may comprise a confirmation that no changes are required to the optimized schedule generated by the system. In other words, the user may accept the generated schedule without providing any modifications. As shown in block 535, the system receives the response from the user via the dynamic editable user interface. The system based on receiving the response comprising at least one change from the user, determines that the at least one change complies with the one or more rules and is in alignment with the one or more change windows and modifies the schedule based on the at least one change. As shown in block 540, the system in response to receiving the response from the user, automatically upgrades the one or more entity resources based on the schedule and the response received from the user.

In some embodiments, after generating the schedule for upgrading the one or more entity resources, the system may identify at least one entity resource of the one or more entity resources as a critical resource and may display the at least one entity resource in the schedule via one or more highlighter graphical elements in the dynamic editable user interface. The system may determine the at least one entity resource as a critical resource based on the information extracted from the data repository 290 and the data repository 390. In some embodiments, the system may determine the at least one entity resource as a critical resource based on number of software applications supported by the at least one entity resource, number of other entity resources connected to the at least one entity resource, number of operations performed using the at least one entity resource, and/or the like. In some embodiments, after determining the at least one entity resource as a critical resource, the system may then prompt the user to provide the input associated with the at least one entity resource in the schedule via the dynamic editable user interface and may receive a response associated with the at least one entity resource from the user via the dynamic editable user interface. In some embodiments, the system prompt the user to provide the input after determining that the at least one entity resource that is identified as a critical resource does not have redundancy (e.g., duplicate resource as a backup if the at least one entity resource is unavailable during upgrade). In some embodiments, the system may modify the schedule based on the response from the user. In some other embodiments, the system may receive a confirmation to implement the schedule as the response from the user and the system may proceed to automatically upgrade the one or more entity resources based on the schedule.

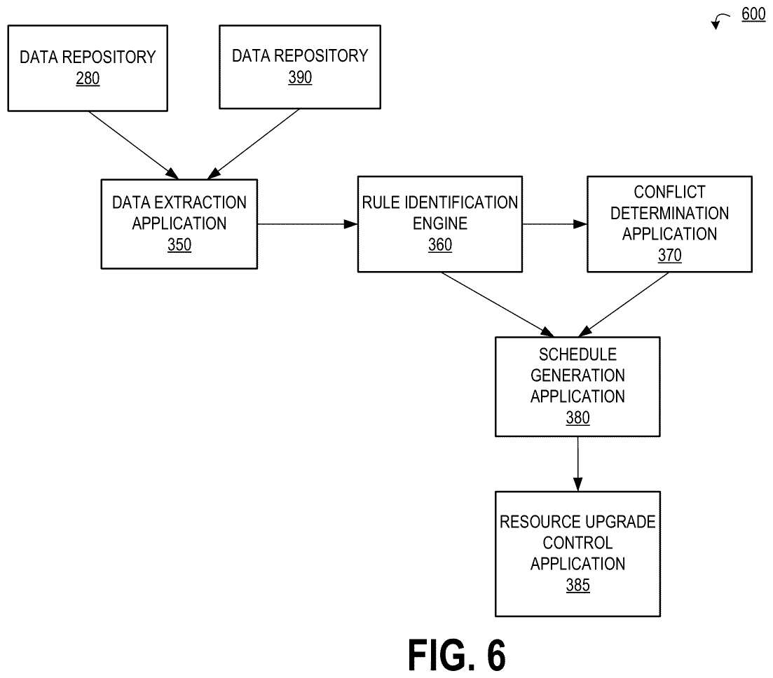

FIG. 6 provides a block diagram illustrating the process of optimizing configuration of resource upgrades, in accordance with an embodiment of the invention. As shown, the data extraction application 350 extracts data associated with the one or more entity resources 201 from the data repository 290 in the entity system 200 and the data repository 390 in the system of the invention. The data extraction application 350 then transmits the extracted data to the rule identification engine 360 for identification of the one or more rules associated with upgrading the one or more entity resources 201. The conflict determination application 370 determines the one or more change windows for upgrading the one or more entity resources based on the one or more rules. The schedule generation application 380 may generate an optimized schedule for upgrading the one or more entity resources 201 based on the one or more rules and the one or more change windows and the resource upgrade control application 385 may automatically implement upgrade of the one or more entity resources 201 based on the optimized schedule generated by the schedule generation application 380.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for optimizing configuration of resource upgrades, comprising:
at least one processing device;
at least one memory device; and
a module stored in the at least one memory device comprising executable instructions that when executed by the at least one processing device, cause the at least one processing device to:
identify one or more entity resources that meet one or more conditions associated with upgrading the one or more entity resources;
identify one or more rules associated with upgrading the one or more entity resources;
determine one or more change windows for upgrading the one or more entity resources based at least on the one or more rules;
generate a schedule for upgrading the one or more entity resources based on the one or more rules and the one or more change windows;
display the schedule for upgrading the one or more entity resources to a user, via a dynamic editable user interface;
prompt the user to provide an input associated with the schedule via the dynamic editable user interface;
receive the response from the user via the dynamic editable user interface; and
in response to receiving the response from the user, automatically upgrade the one or more entity resources based on the schedule and the response received from the user.

2. The system according to claim 1, wherein receiving the response from the user comprises receiving at least one change to the schedule via one or more edit functionalities in the dynamic editable user interface.

3. The system according to claim 2, wherein the executable instructions cause the at least one processing device to:
determine that the at least one change complies with the one or more rules and is in alignment with the one or more change windows; and
modify the schedule based on the at least one change.

4. The system according to claim 1, wherein the executable instructions cause the at least one processing device to:
identify at least one entity resource of the one or more entity resources as a critical resource; and
display the at least one entity resource in the schedule via one or more highlighter graphical elements in the dynamic editable user interface.

5. The system according to claim 4, wherein the executable instructions cause the at least one processing device to:
prompt the user to provide the input associated with the at least one entity resource in the schedule via the dynamic editable user interface; and
receive the response associated with the at least one entity resource from the user via the dynamic editable user interface.

6. The system according to claim 1, wherein the one or more rules comprise at least one of application requirements, freeze requirements, network requirements, and resiliency requirements.

7. The system according to claim 1, wherein the one or more conditions comprise at least one of malfunctioning of at least one hardware component, expiration of warranty of one or more components of the one or more entity systems, expiration of licenses of the one or more components of the one or more entity systems, availability of new software updates, availability of new hardware upgrades, scheduled security upgrades, availability of new security upgrade, scheduled transfer of data, and availability of new data required for performing one or more actions.

8. A computer program product for optimizing configuration of resource upgrades, comprising a non-transitory computer-readable storage medium having computer-executable instructions for:
identifying one or more entity resources that meet one or more conditions associated with upgrading the one or more entity resources;
identifying one or more rules associated with upgrading the one or more entity resources;
determining one or more change windows for upgrading the one or more entity resources based at least on the one or more rules;
generating a schedule for upgrading the one or more entity resources based on the one or more rules and the one or more change windows;
displaying the schedule for upgrading the one or more entity resources to a user, via a dynamic editable user interface;
prompting the user to provide an input associated with the schedule via the dynamic editable user interface;
receiving the response from the user via the dynamic editable user interface; and
in response to receiving the response from the user, automatically upgrading the one or more entity resources based on the schedule and the response received from the user.

9. The computer program product according to claim 8, wherein receiving the response from the user comprises receiving at least one change to the schedule via one or more edit functionalities in the dynamic editable user interface.

10. The computer program product according to claim 9, wherein the non-transitory computer-readable storage medium comprises computer-executable instructions for:
determining that the at least one change complies with the one or more rules and is in alignment with the one or more change windows; and
modifying the schedule based on the at least one change.

11. The computer program product according to claim 8, wherein the non-transitory computer-readable storage medium comprises computer-executable instructions for:
identifying at least one entity resource of the one or more entity resources as a critical resource; and
displaying the at least one entity resource in the schedule via one or more highlighter graphical elements in the dynamic editable user interface.

12. The computer program product according to claim 11, wherein the non-transitory computer-readable storage medium comprises computer-executable instructions for:
prompting the user to provide the input associated with the at least one entity resource in the schedule via the dynamic editable user interface; and
receiving the response associated with the at least one entity resource from the user via the dynamic editable user interface.

13. The computer program product according to claim 8, wherein the one or more rules comprise at least one of application requirements, freeze requirements, network requirements, and resiliency requirements.

14. The computer program product according to claim 8, wherein the one or more conditions comprise at least one of malfunctioning of at least one hardware component, expiration of warranty of one or more components of the one or more entity systems, expiration of licenses of the one or more components of the one or more entity systems, availability of new software updates, availability of new hardware upgrades, scheduled transfer of data, and availability of new data required for performing one or more actions.

15. A computerized method for optimizing configuration of resource upgrades, the method comprising:
identifying one or more entity resources that meet one or more conditions associated with upgrading the one or more entity resources;
identifying one or more rules associated with upgrading the one or more entity resources;
determining one or more change windows for upgrading the one or more entity resources based at least on the one or more rules;
generating a schedule for upgrading the one or more entity resources based on the one or more rules and the one or more change windows;
displaying the schedule for upgrading the one or more entity resources to a user, via a dynamic editable user interface;
prompting the user to provide an input associated with the schedule via the dynamic editable user interface;
receiving the response from the user via the dynamic editable user interface; and
in response to receiving the response from the user, automatically upgrading the one or more entity resources based on the schedule and the response received from the user.

16. The computerized method according to claim 15, wherein receiving the response from the user comprises receiving at least one change to the schedule via one or more edit functionalities in the dynamic editable user interface.

17. The computerized method according to claim 16, wherein the method comprises:
determining that the at least one change complies with the one or more rules and is in alignment with the one or more change windows; and
modifying the schedule based on the at least one change.

18. The computerized method according to claim 15, wherein the method comprises:
identifying at least one entity resource of the one or more entity resources as a critical resource; and
displaying the at least one entity resource in the schedule via one or more highlighter graphical elements in the dynamic editable user interface.

19. The computerized method according to claim 18, wherein the method comprises:
prompting the user to provide the input associated with the at least one entity resource in the schedule via the dynamic editable user interface; and
receiving the response associated with the at least one entity resource from the user via the dynamic editable user interface.

20. The computerized method according to claim 15, wherein the one or more conditions comprise at least one of malfunctioning of at least one hardware component, expiration of warranty of one or more components of the one or more entity systems, availability of new software updates, availability of new hardware upgrades, scheduled transfer of data, and availability of new data required for performing one or more actions.
